(19) United States
(12) Patent Application Publication
(10) Pub. No.: US 2012/0204842 A1
(43) Pub. Date: Aug. 16, 2012

(54) EVAPORATIVE FUEL TREATMENT DEVICE

(75) Inventor: Shinsuke Kiyomiya, Seto-shi (JP)

(73) Assignee: TOYOTA JIDOSHA KABUSHIKI KAISHA, Toyota-shi (JP)

(21) Appl. No.: 13/372,617

(22) Filed: Feb. 14, 2012

(30) Foreign Application Priority Data
Feb. 14, 2011 (JP) 2011-028939

(51) Int. Cl. F02M 33/02

(52) U.S. Cl. 123/520

(57) ABSTRACT

A purge valve and an atmosphere opening valve are closed at a timing for stopping purge, so that a canister is sealed from an atmosphere. Thus, even when purge is stopped, the interior of the canister can be held in a negative pressure state. Therefore, adsorbed fuel does not return to inner depths of pores of an adsorbent, thus maintaining a state where the fuel is present on a surface side of the adsorbent. Thus, when purge is resumed, fuel vapors are swiftly discharged to an intake passage of an internal combustion engine via a purge passage. Thereafter as well, fuel vapors continue to be discharged due to the fuel rising to the surface from the inner depths of the pores of the adsorbent. When purge is thus resumed, fuel vapors are immediately discharged from the canister with no time lag.

### CROSS REFERENCE TO RELATED APPLICATIONS

This application claims priority to Japanese Patent Application No. 2011-028939 filed on Feb. 14, 2011, which is incorporated herein by reference in its entirety including the specification, drawings and abstract.

### BACKGROUND OF THE INVENTION

1. Field of the Invention

The invention relates to an evaporative fuel treatment device that discharges evaporative fuel in a fuel tank to an intake passage of an internal combustion engine via a canister by controlling a purge valve and an atmosphere opening valve.

2. Description of Related Art

There is known an evaporative fuel treatment device that causes fuel vapors generated from a fuel tank during the stoppage of an internal combustion engine to be adsorbed by an adsorbent in a canister and discharges the fuel adsorbed by the adsorbent in the canister to an intake system as vapors to prevent the fuel vapors from leaking to outside air (e.g., see Japanese Patent Application Publication No. 2001-241363 (JP-A-2001-241363), Japanese Patent Application Publication No. 11-294268 (JP-A-11-294268), and Japanese Patent Application Publication No. 8-135521 (JP-A-8-135521)).

In Japanese Patent Application Publication No. 2001-241363 (JP-A-2001-241363), during purge, a purge cut valve is opened to ensure that an intake negative pressure sufficiently spreads in a canister. Thus, the separation of fuel vapors from an adsorbent in the canister is promoted. In the case where purge is not executed, the purge cut valve is closed and the interior of the canister is opened to the atmosphere to ensure that fuel vapors from a fuel tank are adsorbed by the adsorbent.

In Japanese Patent Application Publication No. 11-294268 (JP-A-11-294268), with a view to preventing fuel vapors from being discharged from a canister into the atmosphere when an internal combustion engine has been stopped for a long time, the canister is held in communication with an intake passage during the stoppage of the internal combustion engine. In Japanese Patent Application Publication No. 8-135521 (JP-A-8-135521), an electromagnetic valve repeatedly shuts off/opens an atmosphere and a fuel tank side from/to each other during purge, thereby promoting the separation of fuel vapors from an adsorbent in a canister. When an internal combustion engine is stopped, the canister is opened to the atmosphere and the fuel tank side.

In each of Japanese Patent Application Publication No. 2001-241363 (JP-A-2001-241363) and Japanese Patent Application Publication No. 8-135521 (JP-A-8-135521), the interior of the canister is opened to the atmosphere when purge is not executed. In Japanese Patent Application Publication No. 11-294268 (JP-A-11-294268) as well, the canister is held in communication with the intake passage during the stoppage of the internal combustion engine. Therefore, the canister is substantially opened to the atmosphere in a state where purge is not executed.

An adsorbent accommodated inside a canister, such as activated carbon or the like, has fuel vapors liquefied and adsorbed on a surface thereof and in pores thereof. When purge is executed, the pressure of the ambient air around the adsorbent becomes negative, so that fuel vapors are discharged by first being diffused from the surface of the adsorbent into an air current around the adsorbent. The fuel adsorbed in the pores of the adsorbent gradually flows toward the surface of the adsorbent in the pores in such a manner as to be sucked out by the negative pressure, and is eventually discharged from the surface of the adsorbent into the air current as vapors.

The fuel vapors thus discharged from the adsorbent are discharged, while being carried on the air current, into the intake passage of the internal combustion engine. When purge is stopped, a purge passage of the canister is closed, and the interior of the canister is connected to a fuel tank side and an atmosphere. Accordingly, the ambient air around the adsorbent inside the canister shifts from a negative pressure state to an atmospheric pressure state.

Thus, the adsorbed fuel that has been sequentially supplied to the surface of the adsorbent after flowing from the depths of the adsorbent to the pores thereof not only stops flowing but also flows backward in the pores due to the ambient air that has reached a high pressure due to the atmosphere. This adsorbed fuel returns again to the inner depths of the pores of the adsorbent, thus creating a state where almost no fuel is present on the surface side of the adsorbent.

Accordingly, even when purge is started again, the adsorbent in the canister assumes, at the beginning, a state where almost no fuel is present on the surface side thereof. Thus, the discharge of fuel vapors is not started immediately after the start of purge. The discharge of fuel vapors is started only when fuel rises from the inner depths of the pores of the adsorbent to the surface thereof due to a negative pressure.

There is such a time lag from a time point when purge is started to a time point when fuel vapors are actually discharged. Therefore, should purge with a period shorter than the time lag be repeated due to a certain operation state of the internal combustion engine, there arises a phenomenon that the adsorbed fuel only flows back and forth between the inner depths of the pores of the adsorbent and the vicinity of the surface thereof and almost no fuel vapors are discharged. Alternatively, there arises a phenomenon that only fuel vapors whose amount is smaller than anticipated are discharged. Thus, there is an apprehension that the canister cannot sufficiently exert its performance.

### SUMMARY OF THE INVENTION

The invention makes it possible to swiftly start discharging fuel vapors from a canister when purge is started.

A first aspect of the invention relates to an evaporative fuel treatment device that is equipped with a canister in which an adsorbent that adsorbs fuel vapors is accommodated, an evaporative fuel passage that connects the canister and an upper space of a fuel tank to each other, a purge passage that connects the canister and an intake passage of an internal combustion engine to each other, an atmosphere passage that communicates between the canister and an atmosphere, a purge valve that is opened/closed the purge passage, an atmosphere opening valve that is opened/closed in the atmosphere passage, and a purge control portion that executes purge to discharge evaporative fuel in the fuel tank to the intake passage of the internal combustion engine via the canister by controlling the purge valve and the atmosphere opening valve. The purge control portion performs a sealing processing to seal the canister at least from the atmosphere at a timing for stopping the purge, and terminates the sealing processing at a timing for starting the purge.

According to the foregoing configuration, the purge control portion seals the canister as described above at the timing for stopping purge. Therefore, after the stoppage of purge as well, the interior of the canister assumes a negative pressure state in the same manner as when purge is executed.

During the execution of purge, the interior of the canister is at a negative pressure due to the introduction of an intake negative pressure from the intake passage, and an air current is created in the canister through the introduction of the atmosphere from the atmosphere passage which results from this negative pressure. Thus, the fuel adsorbed by the adsorbent in the canister flows in such a manner as to be sequentially sucked out from the inner depths of the pores of the adsorbent to the surface of the adsorbent, and is discharged from the surface of the adsorbent into the air current in the canister.

When purge is stopped, fuel stops flowing from the inner depths of the pores of the adsorbent to the surface of the adsorbent. However, the interior of the canister is sealed and hence is not opened to the atmosphere. Thus, the adsorbed fuel can be prevented from flowing backward in the pores to return to the inner depths, so that it is possible to maintain a state where the adsorbed fuel is present on the surface side of the adsorbent.

In the case where the sealing processing is terminated and purge is started again, a sufficient amount of fuel is present on the surface of the adsorbent in the canister at the beginning of the resumption of the purge as well. Thus, fuel vapors are swiftly discharged into the air current, and hence can be swiftly discharged into the intake passage as well. Thereafter as well, fuel flows from the depths of the adsorbent to the surface thereof, so that the discharge of fuel vapors is continued.

Thus, the discharge of fuel vapors from the canister can be swiftly started when purge is started. Besides, for this reason, even when short-period purge is repeated, fuel vapors whose amount corresponds to each of purge periods can be reliably discharged into the intake passage each time purge is executed. As a result, the canister can sufficiently exert its performance.

The purge control portion may perform the sealing processing by closing the atmosphere opening valve as well as the purge valve at the timing for stopping the purge, and may terminate the sealing processing by opening the atmosphere opening valve as well as the purge valve at the timing for starting the purge.

By thus controlling the purge valve and the atmosphere opening valve, the performance and termination of the sealing processing for the canister can be realized in a manner corresponding to the stoppage and execution of purge respectively.

The evaporative fuel treatment device may further be equipped with an internal pressure sensor that directly or indirectly detects an internal pressure of the fuel tank, and the purge control portion may open the atmosphere opening valve when the internal pressure detected by the internal pressure sensor during the sealing processing becomes equal to or higher than a reference pressure or changes by a width equal to or larger than a reference change width.

In association with the sealing of the canister, there are some cases where the pressure in the fuel tank is not released and the internal pressure of the fuel tank rises. In such a case, the gas in the fuel tank needs to be discharged via the canister to release the pressure in the fuel tank.

Accordingly, in the case where the internal pressure detected by the internal pressure sensor becomes equal to or higher than the reference pressure or changes by a width larger than the reference change width, the atmosphere opening valve is opened to release the pressure in the fuel tank. Thus, fuel vapors in the fuel tank can be caused to be adsorbed by the canister.

It should be noted that the internal pressure of the fuel tank may be directly detected by the internal pressure sensor arranged in the fuel tank, or may be indirectly detected at a spot to which the internal pressure of the fuel tank is applied, by an internal pressure sensor that is provided at another location, for example, in the canister or the like.

The purge control portion may open the atmosphere opening valve when the sealing processing lasts for a reference time.

A state where the pressure in the fuel tank is not released due to the sealing of the canister and the internal pressure of the fuel tank rises becomes more likely to arise as the time during which the canister is in a sealed state lengthens. Accordingly, when the sealing processing lasts for the reference time, the atmosphere opening valve is opened to release the pressure in the fuel tank. Thus, fuel vapors in the fuel tank can be caused to be adsorbed by the canister.

A second aspect of the invention is a vehicle that is mounted with the evaporative fuel treatment device, the internal combustion engine, and an electric motor as a drive source for causing the vehicle to travel.

In a vehicle that is thus mounted with an internal combustion engine and an electric motor as drive sources for causing the vehicle to travel, that is, a so-called hybrid vehicle, the frequency with which the internal combustion engine is stopped is high due to automatic stop even when the vehicle travels. Therefore, there is an apprehension that short-period purge may be repeated.

In such a hybrid vehicle as well, the invention makes it possible to swiftly start the discharge of fuel vapors from a canister when purge is started. Therefore, fuel vapors whose amount corresponds to each of purge periods can be reliably discharged to an intake passage each time purge is executed. As a result, the canister can sufficiently exert its performance.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of a drive system in a hybrid vehicle of the first embodiment of the invention;

FIG. 2 is a flowchart of a purge control processing executed by an ECU of the first embodiment of the invention;

FIGS. 3A and 3B are timing charts each showing an example of the aforementioned purge control processing;

FIG. 4 is a schematic diagram of a drive system in a gasoline engine vehicle of the second embodiment of the invention; and

FIG. 5 is a flowchart of a purge control processing executed by an ECU of the second embodiment of the invention.

### DETAILED DESCRIPTION OF EMBODIMENTS

### Embodiment 1

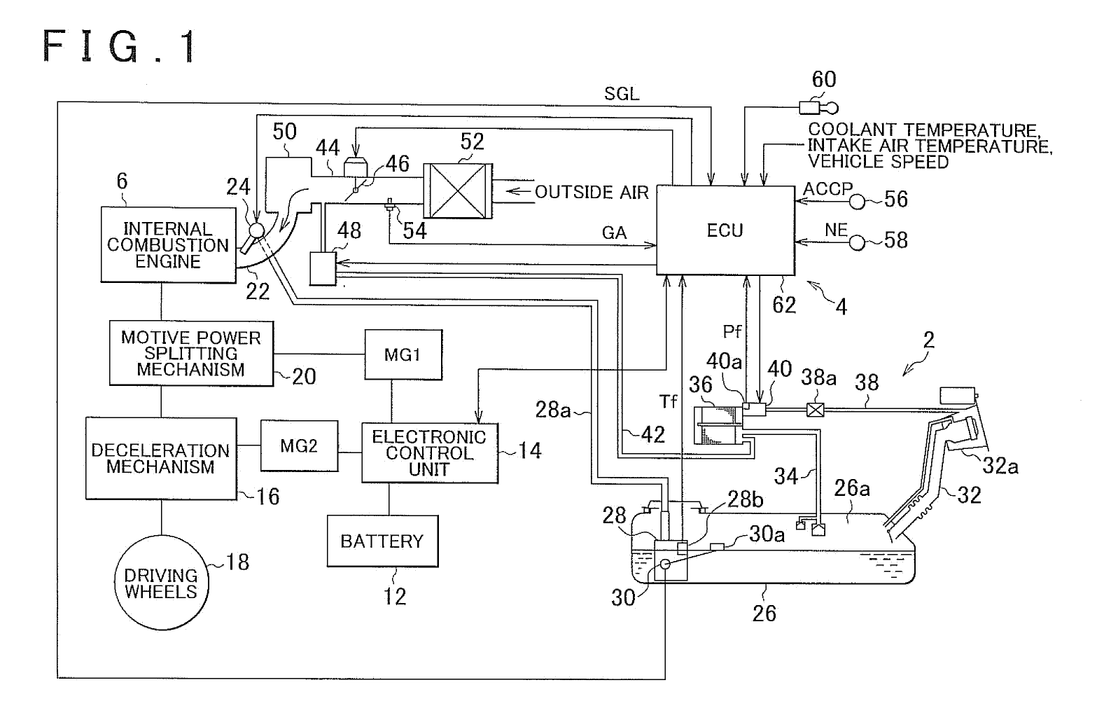

FIG. 1 shows a drive system in a hybrid vehicle. This drive system is equipped with an internal combustion engine 6, which has an internal combustion engine fuel system 2 and an internal combustion engine control system 4, and an electric motor (a later-described motor-generator MG 2). This internal combustion engine 6 is a gasoline engine.

Rotational driving forces from the internal combustion engine 6 and the motor-generator MG2 are decelerated by a deceleration mechanism 16, and are transmitted to driving wheels 18. A motive power splitting mechanism 20 is arranged between the internal combustion engine 6 and the deceleration mechanism 16, so that the rotational driving force of the internal combustion engine 6 can be supplied in a split manner to the deceleration mechanism 16 side and to a motor-generator MG1 that serves as a generator for a battery 12.

It should be noted that each of the two motor-generators MG1 and MG2 functions as both a generator and an electric motor, and according to need, a changeover can be made between the functions thereof. The operation of the two motor-generators MG1 and MG2 is optionally controlled, at least in part, by electronic control unit 14. Fuel injection valves 24 are arranged in intake ports 22 for respective cylinders of the internal combustion engine 6, respectively. Fuel stored in a fuel tank 26 is force-fed to these fuel injection valves 24 via a fuel channel 28a by a fuel pump module 28. Then, through fuel injection control, fuel is injected from the fuel injection valves 24 at a predetermined timing, sucked into the respective cylinders, and burned. Thus, the internal combustion engine 6 is driven.

Furthermore, a fuel temperature sensor 28b is arranged in such a manner as to accompany the fuel pump module 28. This fuel temperature sensor 28b detects a fuel temperature of the internal combustion engine fuel system 2, especially a fuel temperature Tf in the fuel tank 26 in this case.

A fuel sender gauge 30 for detecting a fuel liquid level SGL in the fuel tank 26 using a float 30a is provided in the fuel tank 26. In feeding fuel, fuel is introduced into the fuel tank 26 from a fuel inlet pipe 32. An upper space 26a of the fuel tank 26 is connected to a canister 36 by an evaporative fuel passage 34. The canister 36 is equipped therein with an adsorbent for adsorbing fuel, such as activated carbon or the like, and adsorbs fuel vapors that are discharged from the upper space 26a of the fuel tank 26 via the evaporative fuel passage 34.

An atmosphere passage 38 that communicates with a fuel inlet box 32a provided in the fuel inlet pipe 32 is connected to the canister 36. An air filter 38a is provided such that this atmosphere passage 38 extends therethrough. In addition, the atmosphere passage 38 is provided with an atmosphere opening valve 40 as a normally-open electromagnetic valve at a position located on the canister 36 side with respect to the air filter 38a. An internal pressure sensor 40a, which detects an internal pressure Pf on the canister 36 side with respect to the atmosphere opening valve 40, is provided in such a manner as to accompany this atmosphere opening valve 40.

Furthermore, the canister 36 is connected to an intake passage 44 of the internal combustion engine 6 at a position downstream of a throttle valve 46 by a purge passage 42. A purge valve 48 as a normally-closed electromagnetic valve is arranged such that the purge passage 42 extends therethrough.

This purge valve 48 and the atmosphere opening valve 40 are opened, so that purge is executed. That is, an intake negative pressure in the intake passage 44 is introduced into the canister 36 from the purge passage 42 side, so that fuel vapors separate from the adsorbent of the canister 36 to be discharged into the current of air introduced from the atmosphere passage 38 side. Then, fuel vapors carried on the air current are discharged into intake air flowing through the intake passage 44 via the purge passage 42. The intake air, which has flowed into a surge tank 50 and contains purge fuel, is distributed to the intake ports 22 of the respective cylinders, and is burned in combustion chambers of the respective cylinders together with the fuel injected from the fuel injection valves 24.

In the intake passage 44, an airflow meter 54 is provided between an air filter 52 and the throttle valve 46 to detect an intake air amount GA (g/sec), that is, an amount of intake air supplied to the internal combustion engine 6.

Besides, an accelerator opening degree sensor 56, which is provided on an accelerator pedal operated by a driver of the vehicle to detect an accelerator opening degree ACCP, an engine rotational speed sensor 58 that detects a rotational speed NE of a crankshaft of the internal combustion engine 6, an ignition switch (an IGSW) 60, and other sensors/switches are provided to output signals respectively. Mentionable as other signals are, for example, those indicating a coolant temperature, an intake air temperature, a vehicle speed, and the like.

Detection signals of the fuel temperature sensor 28b, the fuel sender gauge 30, the airflow meter 54, the accelerator opening degree sensor 56, the engine rotational speed sensor 58, the IGSW 60, and the like are input to an electronic control unit (hereinafter referred to as an ECU) 62, which is mainly composed of a microcomputer.

Then, on the basis of data on these signals and data stored in advance, the ECU 62 performs a calculation processing to control the fuel injection valves 24, the throttle valve 46, and the like. In addition, the ECU 62 performs a purge control processing, which will now be described below.

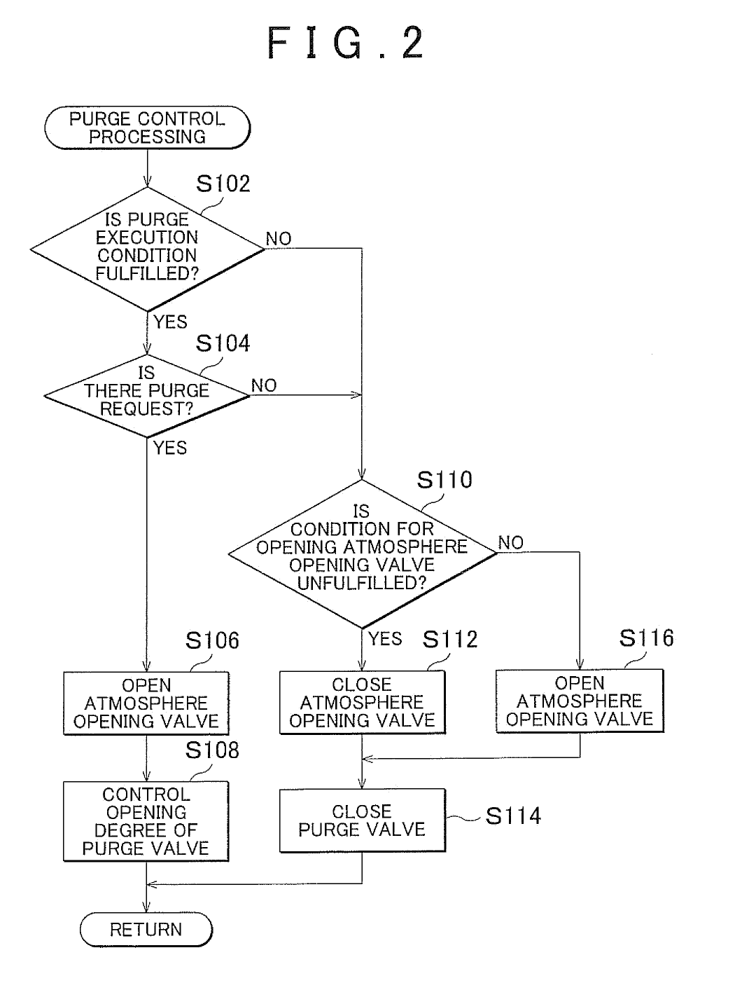

Next, the operation of this embodiment of the invention will be described referring to the purge control processing (FIG. 2) executed by the ECU 62. This processing is a processing that is repeatedly performed on a short time cycle. It should be noted that a step in a flowchart corresponding to each of processing contents is denoted by “S-”.

When the purge control processing is started, it is first determined whether or not a purge execution condition is fulfilled (S102). The purge execution condition is a condition that allows purge control to be performed. For example, a state where the warm-up of the internal combustion engine 6 is terminated after the start thereof and an air-fuel ratio feedback correction, an air-fuel ratio learning correction, and the like are terminated is regarded as a state where the purge execution condition is fulfilled. It should be noted that the purge execution condition is unfulfilled when the internal combustion engine 6 is automatically stopped through intermittent control, which is the control in a hybrid vehicle, or the like.

When the purge execution condition is fulfilled (YES in S102), it is then determined whether or not there is a purge request (S104). The purge request is a request that is separately made when it is estimated, on the basis of an integrated purge gas amount calculated by the ECU 62, that fuel vapors remain in the adsorbent in the caster 36. That is, the purge request lasts unless the fuel adsorbed in the canister 36 completely vanishes.

It should be noted that the integrated purge gas amount is obtained by calculating a purge gas flow rate (a purge gas amount per unit time) on the basis of, for example, an intake pipe negative pressure (which is calculated from the intake air amount GA and the rotational speed NE) and an opening degree of the purge valve 48 (which is a duty ratio in duty control), multiplying this purge gas flow rate by a purge control processing performance cycle, and integrating this product obtained through multiplication for each cycle.

Until this integrated purge gas amount becomes equal to or larger than a maximum adsorption amount resulting from the adsorbent in the canister 36, there is a purge request. When this integrated purge gas amount becomes equal to or larger than the maximum adsorption amount, there is no purge request. Thereafter, when fuel vapors are adsorbed again by the canister 36 to the maximum, the integrated purge gas amount is cleared to “0”, thus creating a state where there is a purge request.

It should be noted that the state where fuel vapors are adsorbed again by the canister 36 to the maximum refers to, for example, a case where the travel distance becomes equal to or longer than a predetermined distance or the travel time becomes equal to or longer than a predetermined time with the internal combustion engine 6 in continuous operation, a case where the internal combustion engine 6 has just been started through the operation of an ignition key immediately after the feeding of fuel, and the like.

When there is a purge request (YES in S104), the atmosphere opening valve 40 is then opened (S106). Thus, the interior of the canister 36 communicates with the atmosphere outside the vehicle via the fuel inlet box to assume a state of being open to the atmosphere. When the atmosphere opening valve 40 is open, the state of being open to the atmosphere is maintained.

Furthermore, for the sake of purge control, the opening degree of the purge valve 48 is controlled (S108). It should be noted herein that opening degree control is performed through duty control, and that an appropriate purge gas flow rate is realized so as not to destabilize the air-fuel ratio.

Thus, the present processing is temporarily exited. When the purge execution condition is fulfilled (YES in S102) and there is a purge request (YES in S104), the aforementioned processing is continued. Thus, the atmosphere-side air is sucked into the canister 36 from the atmosphere passage 38 due to an intake negative pressure that is introduced from the intake passage 44 side via the purge passage 42.

Thus, the fuel adsorbed by the adsorbent in the canister 36 is discharged, as fuel vapors, into the air current flowing in from the atmosphere passage 38, and is discharged, as purge gas, into the intake passage 44 while carrying on this air current. In the meantime, the integrated purge gas amount is calculated as described above.

A case where the internal combustion engine 6 is automatically stopped through intermittent control and the purge execution condition is unfulfilled (NO in S102) with the adsorbed fuel remaining in the adsorbent in the canister 36, namely, with the integrated purge gas amount below the maximum adsorption amount (there is a purge request) in executing purge as described above will be taken into account.

In this case, it is determined whether or not a condition for opening the atmosphere opening valve 40 is unfulfilled (S110). This condition for opening the atmosphere opening valve 40 is a logical addition of two conditions a and b shown below.

a. that the period in which the closed state of the atmosphere opening valve 40 lasts be longer than a reference time.

b. that the internal pressure Pf of the canister 36 detected by the internal pressure sensor 40a (in fact, the pressure of the upper space 26a of the fuel tank 26, which communicates with the canister 36) be higher than a reference pressure.

When at least of one of these conditions a and b is satisfied, the condition for opening the atmosphere opening valve 40 is fulfilled. When both the conditions a and b are unsatisfied, the condition for opening the atmosphere opening valve 40 is unfulfilled.

Herein, when it is assumed that the condition for opening the atmosphere opening valve 40 is unfulfilled (YES in S110), the atmosphere opening valve 40 is then closed (S112). Thus, the interior of the canister 36 is shut off from the space on the atmosphere, so that no atmosphere is introduced into the canister 36.

Furthermore, the purge valve 48 is closed to stop purge control (S114). Thus, the interior of the canister 36 as well as the upper space 26a of the fuel tank 26 is sealed from the outside. That is, the canister 36 is sealed at least from the space on the atmosphere. Accordingly, a negative pressure state of the intake air introduced just before is maintained in the canister 36 as well as the upper space 26a of the fuel tank 26.

Thus, the present processing is temporarily exited. As long as the purge execution condition is unfulfilled (NO in S102) and the condition for opening the atmosphere opening valve 40 is unfulfilled (YES in S110), the aforementioned processing is continued to hold the interior of the canister 36 in a negative pressure state.

When purge is executed until just before, the following phenomenon occurs in the adsorbent such as activated carbon or the like, which is accommodated inside the canister 36. That is, the fuel adsorbed in a liquefied state in pores of the adsorbent gradually flows in the pores from the inner depths of the adsorbent to the surface thereof in such a manner as to be sucked out by the ambient air at a negative pressure. The fuel is discharged, as vapors, into the air current from the surface of the adsorbent, and besides, is discharged from the purge passage 42 into the intake passage 44 of the internal combustion engine 6 while carrying on the air current.

When the atmosphere opening valve 40 and the purge valve 48 are closed while fuel vapors are thus discharged from the surface of the adsorbent into the air current, the air current around the adsorbent stops, and the discharge of fuel vapors from the adsorbent stops.

Furthermore, since the atmosphere opening valve 40 is closed, the atmospheric pressure is not introduced into the canister 36, and the interior of the canister 36 as well as the upper space 26a of the fuel tank 26 is held in a negative pressure state that is introduced when purge is executed. Accordingly, the fuel present on the surface of the adsorbent is not pushed back into the inner depths of the pores due to the atmospheric pressure even in a purge stop state.

If the atmosphere opening valve 40 is open during the stoppage of purge as the related art, the atmospheric pressure is introduced into the canister 36 immediately. If the atmosphere is immediately introduced into the canister 36 during the stoppage of purge, the fuel present on the surface of the adsorbent is pushed back into the pores, and thereafter as well, is pushed from shallow regions of the pores to the inner depths thereof. Therefore, even when purge is resumed, it takes a long time until the adsorbed fuel reaches the surface of the adsorbent and the discharge of fuel vapors into the air current is actually made possible.

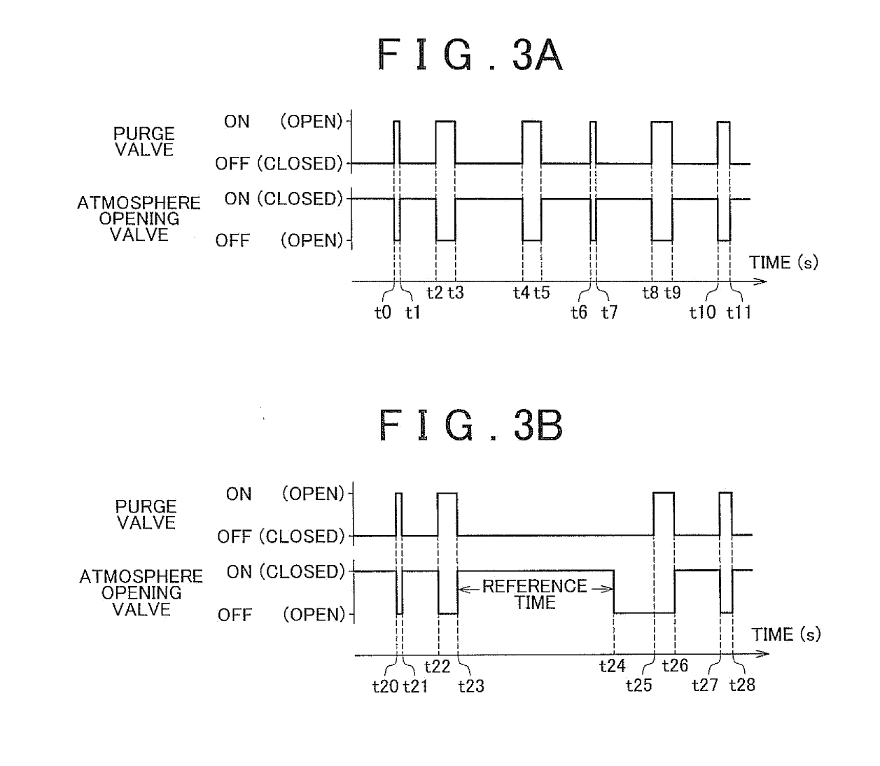

In this embodiment, for example, when purge execution periods (t0 to t1, t2 to t3, t4 to t5, t6 to t7, t8 to t9, and t10 to t11) are repeated on a short time cycle, the purge valve 48 and the atmosphere opening valve 40 are opened or closed repeatedly as shown in FIG. 3A. However, in related art, the fuel from the inner depths of the pores has not reached the surface of the adsorbent at the beginning of each of the purge execution periods because the canister is not in the negative pressure state, and the discharge of fuel vapors from the purge passage 42 into the intake passage 44 cannot be started in the related example.

Accordingly, in the related art, as shown in FIG. 3A, when the purge execution periods are short, the fuel that has reached the vicinity of the surface of the adsorbent during the purge execution periods returns again to the inner depths of the pores during purge stop periods (t1 to t2, t3 to t4, t5 to t6, t7 to t8, and t9 to t10), respectively. Accordingly, no matter how many times such short-period purge is executed, the amount of the fuel adsorbed in the canister 36 does not decrease.

In this embodiment of the invention, however, when purge is stopped, the atmosphere opening valve 40 is closed to prevent the atmosphere from flowing from the atmosphere passage 38 into the canister 36 and seal the canister 36 at least from the atmosphere. Thus, the fuel on the surface of the adsorbent can be retained even in a purge stop state.

Accordingly, when the purge condition is fulfilled again (YES in S102), the integrated purge gas amount has not reached the maximum adsorption amount yet at this moment, and it is therefore determined that there is a purge request (YES in S104). The atmosphere opening valve 40 is then opened (S106), and the purge valve 48 is opened in a controlled state (S108). Thus, the fuel present on the surface of the adsorbent in the canister 36 is immediately discharged into the air current passing through the canister 36, and is discharged, together with the air current, into the intake passage 44 of the internal combustion engine 6 via the purge passage 42. Thus, fuel vapors are immediately discharged into the intake passage 44 when purge control is started.

Then, the execution of purge and the stoppage of purge are thus repeated afterward. In the case where the integrated purge gas amount reaches the maximum adsorption amount, even when the purge execution condition is fulfilled (S102), there is no purge request (NO in S104). It is therefore determined whether or not the condition for opening the atmosphere opening valve 40 is unfulfilled (S110).

Then, when the condition for opening the atmosphere opening valve 40 is unfulfilled (YES in S110), the closing of the atmosphere opening valve 40 (S112) and the closing of the purge valve 48 (S114) are carried out. Thereafter, the state where the atmosphere opening valve 40 and the purge valve 48 are closed (the sealed state of the canister 36) lasts unless at least one of the conditions a and b for opening the atmosphere opening valve 40 is fulfilled (YES in S110).

Thereafter, when the period during which the closed state of the atmosphere opening valve 40 lasts exceeds a reference time or when the internal pressure Pf on the canister 36 side (which corresponds to the internal pressure of the fuel tank 26) exceeds a reference pressure (NO in S110), the atmosphere opening valve 40 is opened (S116). The purge valve 48 is held closed (S114).

Thus, fuel vapors generated in the fuel tank 26 are adsorbed by the adsorbent in the canister 36, and the post-adsorption air is discharged into the fuel inlet box 32a via the atmosphere passage 38. That is, this air is discharged to the atmosphere.

FIG. 3B shows a case where the period during which the closed state of the atmosphere opening valve 40 lasts exceeds the reference time. As shown in FIG. 3B, in the case where the unfulfilled state of the purge execution condition (NO in S102) lasts for a long time (after t23) when there is a purge request, the condition for opening the atmosphere opening valve 40 is fulfilled (NO in S110). Thus, the atmosphere opening valve 40 is opened (S116: t24). The purge valve 48 is held closed (S114: t24-t25).

Thus, when the fuel vapor pressure in the fuel tank 26 rises or may rise while the execution of purge is suspended with the canister 36 and the fuel tank 26 sealed, the atmosphere opening valve 40 is opened (after t24) even in the case where there is a purge request. The pressure in the fuel tank 26 is thereby released to the atmosphere via the canister 36. In the aforementioned configuration, the ECU 62 can be regarded as the purge control portion, and the purge control processing of FIG. 2 can be regarded as the processing performed by the purge control portion.

(1) In the purge control processing (FIG. 2), at a timing for stopping purge, the purge valve 48 is closed and the atmosphere opening valve 40 is closed, so as to seal the canister from the atmosphere (S112 and S114). Thus, even in the case where purge is stopped, a negative pressure state can be maintained in the canister 36. Therefore, the adsorbed fuel does not return to the inner depths of the pores of the adsorbent, thus maintaining a state where the fuel is present on the surface side of the adsorbent.

Thus, when purge is resumed, fuel vapors are swiftly discharged into the intake passage 44 of the internal combustion engine 6 via the purge passage 42. Thereafter as well, the discharge of fuel vapors is continued due to the fuel rising from the inner depths of the pores of the adsorbent to the surface thereof.

When purge is thus resumed, fuel vapors are immediately discharged from the canister 36 with no time lag. Therefore, even in the case where short-period purge is repeated, fuel vapors whose amount corresponds to each of the purge periods can be reliably discharged into the intake passage 44 of the internal combustion engine 6 each time purge is executed. As a result, the canister 36 can sufficiently exert its performance.

(2) In this embodiment of the invention, in the purge control processing (FIG. 2), when the internal pressure Pf detected by the internal pressure sensor 40a becomes equal to or higher than a reference pressure (NO in S110), the atmosphere opening valve 40 is opened to release the pressure in the fuel tank 26 (S116).

This rise in the internal pressure Pf of the fuel tank 26 becomes more likely to occur as the time during which the canister 36 is in a sealed state lengthens. Accordingly, even when the sealed state lasts longer than the reference time (NO in S110), the atmosphere opening valve 40 is opened (S116) to release the pressure in the fuel tank 26.

Thus, the fuel vapors generated in the upper space 26a of the fuel tank 26 can be introduced into the canister 36 to be adsorbed by the adsorbent.

(3) In this embodiment of the invention, the internal combustion engine 6 constitutes a drive system together with the electric motor (the motor-generator MG2). In a hybrid vehicle that is thus mounted with the internal combustion engine 6 and the electric motor as drive sources for causing the vehicle to travel, the frequency with which the internal combustion engine 6 is stopped is high due to automatic stop even when the vehicle travels. Therefore, as shown in FIGS. 3A and 3B, short-period purge may be repeated.

In this hybrid vehicle as well, however, this embodiment of the invention makes it possible to swiftly start discharging fuel vapors from the canister 36 when purge is started. Therefore, fuel vapors whose amount corresponds to each of the purge periods can be reliably discharged into the intake passage 44 of the internal combustion engine 6 each time purge is executed. As a result, the canister 36 can sufficiently exert its performance.

### Second Embodiment

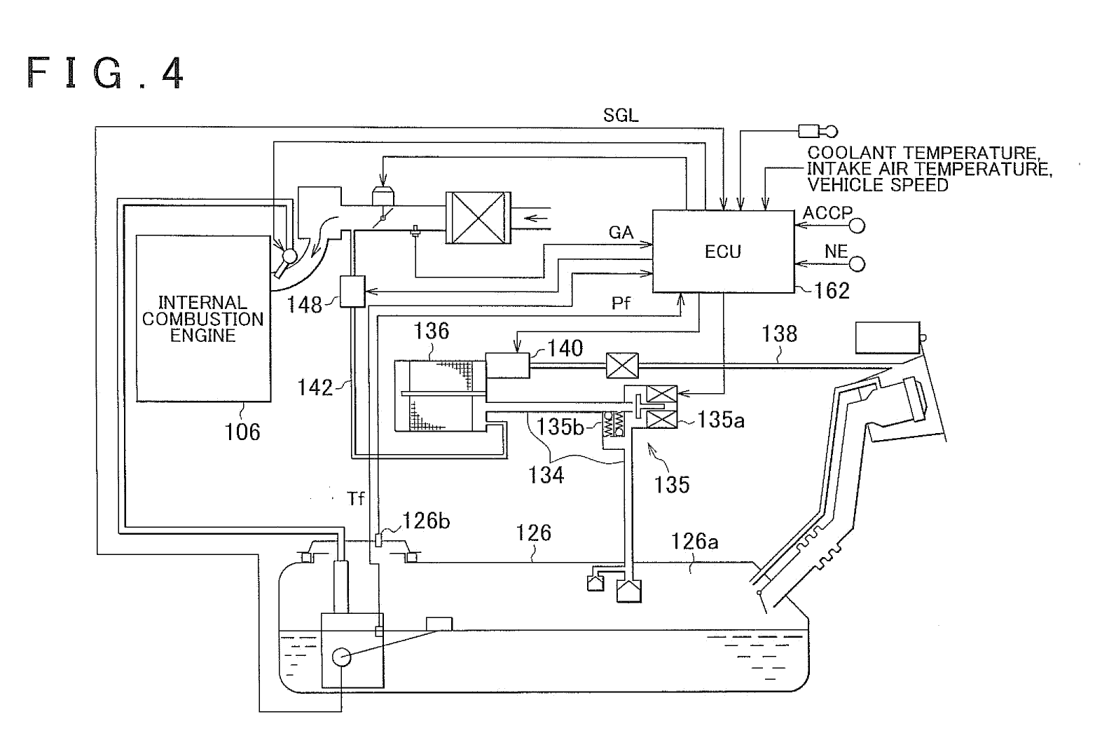

As shown in FIG. 4, this embodiment of the invention deals with a vehicle that is mounted only with an internal combustion engine (a gasoline engine) 106 as a drive source for causing the vehicle to travel, instead of a hybrid vehicle. An evaporative fuel passage 134 that connects an upper space 126a of a fuel tank 126 and a canister 136 to each other is provided with a closure valve unit 135 that is equipped with a closure valve 135a and a relief valve 135b. The closure valve 135a is an electromagnetic valve that is changed over between an open state and a closed state. When the closure valve 135a is opened, the upper space 126a of the fuel tank 126 and the canister 136 communicate with each other through the evaporative fuel passage 134. Thus, fuel vapors generated in the upper space 126a of the fuel tank 126 can be discharged to the canister 136 side. When the closure valve 135a is closed, the evaporative fuel passage 134 is closed off, so that the fuel vapors generated in the upper space 126a of the fuel tank 126 cannot be discharged to the canister 136 side. That is, the interior of the fuel tank 126 is sealed independently of the canister 136 to assume an airtight state. It should be noted that when the difference between the pressure in the evaporative fuel passage 134 on the fuel tank 126 side and the pressure in the evaporative fuel passage 134 on the canister 136 side becomes excessive, the relief valve 135b opens to eliminate this excessive differential pressure.

Furthermore, an atmosphere opening valve 140 provided in an atmosphere passage 138 is not provided with an internal pressure sensor. The fuel tank 126 is provided with an internal pressure sensor 126b that directly detects a pressure in an upper space 126a thereof, namely, the internal pressure Pf of the fuel tank 126.

Other mechanical configurational details are the same as described with reference to FIG. 1 of the foregoing first embodiment of the invention. Accordingly, the canister 136 can be sealed independently of the upper space 126a of the fuel tank 126 by closing all the valves, that is, a purge valve 148 provided in a purge passage 142, the atmosphere opening valve 140 provided in the atmosphere passage 138, and the closure valve 135a provided in the evaporative fuel passage 134.

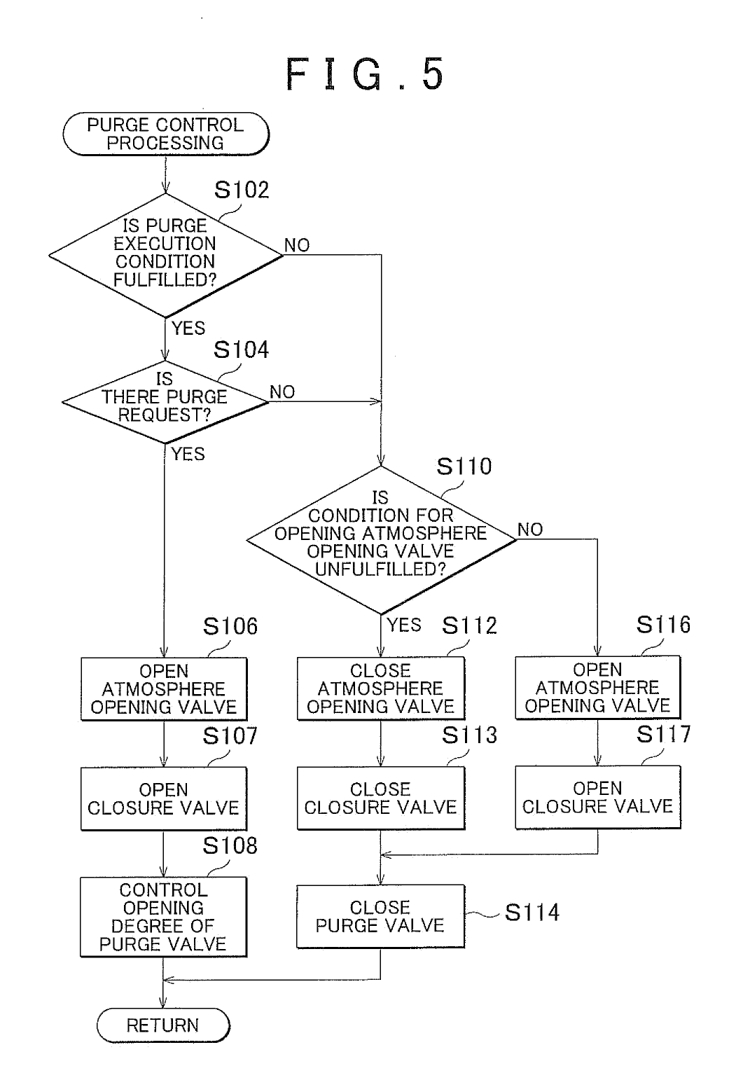

A purge control processing executed by an ECU 162 is shown in FIG. 5. In FIG. 5, the processing contents denoted by the same step numbers as in the aforementioned FIG. 2 are identical to those described with reference to the aforementioned FIG. 2, respectively.

When purge is executed (YES in S102 and YES in S104), a processing of opening the atmosphere opening valve 140, the closure valve 135a, and the purge valve 148 (S106, S107, and S108) is performed. Then, in the case where a purge execution condition is not fulfilled (NO in S102), when a condition for opening the atmosphere opening valve 140 is unfulfilled (YES in S110), a processing of closing the atmosphere opening valve 140, the closure valve 135a, and the purge valve 148 (S112, S113, and S114) is performed.

Furthermore, when the condition for opening the atmosphere opening valve 140 is fulfilled (NO in S110), the atmosphere opening valve 140 and the closure valve 135a are opened (S116 and S117), and a processing of closing the purge valve 148 (S114) is performed. Thus, an operation similar to the operation in the case of the foregoing first embodiment of the invention is achieved. In the aforementioned configuration, the ECU 162 can be regarded as the purge control portion, and the purge control processing of FIG. 5 can be regarded as the processing performed by the purge control portion.

(1) Although the evaporative fuel passage 134 is provided with the closure valve 135a, an effect similar to that of the remarks (1) and (2) of the foregoing first embodiment of the invention can be achieved by performing control as shown in FIG. 5.

### Other Embodiments

In the foregoing first embodiment of the invention, the vehicle is the hybrid vehicle, but may also be a plug-in hybrid vehicle, or a non-hybrid vehicle that is equipped only with an internal combustion engine as a drive source for causing the vehicle to travel, as in the case of the foregoing second embodiment of the invention.

In the foregoing second embodiment of the invention, the vehicle is equipped only with the internal combustion engine as the drive source for causing the vehicle to travel, but may also be a hybrid vehicle as in the case of the foregoing first embodiment of the invention, or a plug-in hybrid vehicle.

In each of the foregoing embodiments of the invention, the condition for opening the atmosphere opening valve 40 or the condition for opening the atmosphere opening valve 140 and the closure valve 135a is the logical addition of the conditions a and b, but may simply be the condition a or the condition b.

The aforementioned condition b for opening the valve is the condition “that the internal pressure Pf be higher than the reference pressure”, but may be the condition “that the change in the internal pressure Pf be equal to or larger than the reference change width”, or the logical addition of the condition “that the internal pressure Pf be higher than the reference pressure” and the condition “that the change in the internal pressure Pf be equal to or larger than the reference change width”.

The reference time in the aforementioned condition a for opening the valve may be set as a constant time, but the length of the reference time may be set in accordance with the fuel temperature Tf in the fuel tank 26, which is detected by the fuel temperature sensor 28b. For example, the reference time is set long when the fuel temperature Tf is low, and set short when the fuel temperature Tf is high.

In the foregoing second embodiment of the invention, the closure valve 135a is also closed when the canister 136 is sealed. However, at the time of automatic stop such as idling stop or the like, or at the time of automatic stop resulting from intermittent control in the case of application to the hybrid vehicle, the atmosphere opening valve 140 and the purge valve 148 may be closed, and the closure valve 135a may be open.

What is claimed is:

1. An evaporative fuel treatment device comprising:
a canister in which an adsorbent that adsorbs fuel vapors is accommodated;
an evaporative fuel passage that connects the canister and an upper space of a fuel tank to each other;
a purge passage that connects the canister and an intake passage of an internal combustion engine to each other;
an atmosphere passage that communicates between the canister and an atmosphere;
a purge valve that is opened/closed in the purge passage;
an atmosphere opening valve that is opened/closed in the atmosphere passage; and
a purge control portion that executes purge to discharge evaporative fuel in the fuel tank to the intake passage of the internal combustion engine via the canister by controlling the purge valve and the atmosphere opening valve, wherein
the purge control portion performs a sealing processing to seal the canister at least from the atmosphere at a timing for stopping the purge, and terminates the sealing processing at a timing for starting the purge.

2. The evaporative fuel treatment device according to claim 1, wherein the purge control portion performs the sealing processing by closing the atmosphere opening valve as well as the purge valve at the timing for stopping the purge, and terminates the sealing processing by opening the atmosphere opening valve as well as the purge valve at the timing for starting the purge.

3. The evaporative fuel treatment device according to claim 2, wherein an internal pressure sensor that directly or indirectly detects an internal pressure of the fuel tank is provided, and
the purge control portion opens the atmosphere opening valve when the internal pressure detected by the internal pressure sensor during the sealing processing becomes equal to or higher than a reference pressure or changes by a width equal to or larger than a reference change width.

4. The evaporative fuel treatment device according to claim 2, wherein the purge control portion opens the atmosphere opening valve when the sealing processing lasts for a reference time.

5. A vehicle comprising:
the evaporative fuel treatment device according to claim 1;
the internal combustion engine; and
an electric motor as a drive source for causing the vehicle to travel.

6. The vehicle according to claim 5, wherein
the atmosphere is outside the vehicle, and
the atmosphere passage communicates the canister and the atmosphere via a fuel inlet box of the vehicle.
